(19) United States
(12) Patent Application Publication
(10) Pub. No.: US 2025/0005438 A1
(43) Pub. Date: Jan. 2, 2025

(54) BIASED SYNTHETIC TEST SETS FOR FAIRNESS CONFIGURATION TECHNICAL FIELD

(71) Applicant: International Business Machines Corporation, Armonk, NY (US)

(72) Inventors: Gabriel Idris Gilling, New York, NY (US); Rakshith Dasenahalli Lingaraju, Palo Alto, CA (US); Courtney Branson, San Diego, CA (US); Aaron T. Smith, Raleigh, NC (US)

(21) Appl. No.: 18/343,245

(22) Filed: Jun. 28, 2023

(51) Int. Cl. G06N 20/00

(52) U.S. Cl. CPC G06N 20/00

(57) ABSTRACT

The invention is to utilize a process in which synthetic data sets are generated that contain intentional bias to run against an AI model. The purpose is to detect potential bias and if detected, perform bias mitigation procedure on the sensitive attributes associated with the bias. The embodiments are a construction component that constructs an initial artificial intelligence (AI) model using a structured data set with continuous, binary or multi-class prediction labels; a generation component that generates synthetic datasets from the training set wherein protected attributes are simulated; and an execution component that runs the initial model against synthetic biased testing data sets to gage robustness of the initial model by scoring the model and exposing protected attributes to target for bias mitigation.

### TECHNICAL FIELD

The disclosed subject matter relates to using synthetically generated biased test data in order to identify and remove bias from artificial intelligence (AI) models.

### BACKGROUND

AI models are trained through machine learning. The specific type of training can vary by model. The process typically involves the following steps: defining the problem, collecting and preprocessing data, feature engineering, initializing and training the model, evaluating and fine-tuning the model, testing the model and deploying the model. However, there may be an inherent problem if the data itself is skewed and this is not recognized when the model is being exercised. In the context of an AI model, a data flaw can be defined as bias. Bias refers to a systematic error or favoritism in the predictions or decisions made by the model. It occurs when the model consistently produces results that are systematically skewed or unfair, often reflecting the existing biases present in the data used to train the model. Bias occurs when the AI model produces inaccurate or unfair predictions or decisions due to the influence of underlying biases present in the training data or the model's design.

The above-described background relating to AI models and bias is merely intended to provide a contextual overview of some current issues and is not intended to be exhaustive.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate a method to proactively insert synthetic data into data sets to train AI models are described.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a construction component that constructs an initial artificial intelligence (AI) model using a structured data set with continuous, binary or multi-class prediction labels, the computer executable components can further comprise a generation component that generates synthetic datasets from the training set wherein protected attributes are oversampled; and an execution component that runs the initial model against synthetic biased testing data sets to gage robustness of the initial model by scoring the model and exposing protected attributes to target for bias mitigation.

According to another embodiment, a computer-implemented method is provided. The computer-implemented method can comprise, constructing, by a system operatively coupled to a processor, an initial model using a structured data set with continuous, binary or multi-class prediction labels; generating by the system synthetic data sets from a training set wherein protected attributes are oversampled; and executing by the system, the initial model against synthetic biased testing data sets to gage robustness of the initial model by scoring the model and exposing protected attributes to target for bias mitigation.

According to yet another embodiment, a computer program product for detecting bias in an AI model is provided. The computer program product can comprise a computer readable storage medium having program instructions embodied therewith, the program instructions executable by a processor to cause the processor to construct, by the processor, an initial artificial intelligence (AI) model using a structured data set with continuous, binary or multi-class prediction labels; generate, by the processor, synthetic datasets from a training set wherein protected attributes are simulated; and execute, by the processor, the initial model against synthetic biased testing data sets to gage robustness of the initial model and expose protected attributes to target for bias mitigation.

### BRIEF DESCRIPTION OF DRAWINGS

FIG. 1 depicts a basic block diagram of the major components of an architecture which the disclosed subject matter can interact/be implemented at least in part, in accordance with various aspects and implementations of the subject disclosure.

FIG. 2 depicts an example of a table with columns representing various data that is used in an AI model for detecting bias in a process, columns identified as protected class, privileged/unprivileged groups, and favorable/unfavorable labels.

FIG. 3 illustrates a process of generating synthetic biased data and implementation of this data to detect bias in an AI model and associated components in accordance with one or more embodiments described herein.

FIG. 4 illustrates a process of generating synthetic biased data and implementation of this data to detect bias in an AI model and associated components in accordance with one or more embodiments described herein.

FIG. 5 illustrates an example of training data that can be used for an AI model to predict “Approval or Rejection” for a specific loan type, in accordance with one or more embodiments described herein.

FIG. 6 illustrates an example of output of a process that can indicate if a model is biased and its specific sensitive attributes associated, in accordance with one or more embodiments described herein.

FIG. 7 illustrates a flow chart diagram in accordance with one or more embodiments described herein.

FIG. 8 depicts an example schematic block diagram of a computing environment with which disclosed subject matter can interact/be implemented at least in part, in accordance with various aspects and implementations of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

An AI model, also known as a machine learning model or an artificial intelligence model, is a mathematical or computational representation of a problem or task that has been trained to make predictions, classify data, or make decisions based on input data. AI models are at the core of machine learning and enable machines to learn from data and perform intelligent tasks without being explicitly programmed. AI models are designed to capture and learn patterns, relationships, and dependencies within data they are trained on. They generalize from the training data to make predictions or decisions on new, unseen data. A process of training an AI model involves feeding it a labeled dataset, allowing the model to adjust its internal parameters and optimize performance based on provided feedback.

AI models are trained through machine learning; the specific type of training can vary by model. The process typically involves: defining a problem, collecting and preprocessing data, feature engineering, initializing and training a model, evaluating and fine-tuning the model, testing the model and deploying the model. In a first step, a problem the model intends to solve is clearly defined and specifying a desire output or prediction is determined. Next data is collected and prepared for training the model. This is done by splitting a dataset, typically into two or more subsets, one to train the model and one to test/validate the model, a separate set may be used to assess the model after training. Third, feature engineering may be applied to extract relevant information from input data. Next, an appropriate type of model (e.g., neural network, decision tree) is selected and its structure is defined. The selected model is initialized with random weights and biases in order to begin iteratively training the model. The model then iteratively adjusts its parameters to minimize difference between its predictions and ground truth (real world) labels. The model is then evaluated using a validation set. Various evaluation metrics are used to assess its accuracy, precision, recall, or other relevant measures. If the model's performance is unsatisfactory, adjustments and fine tuning can occur. After the model has achieved satisfactory performance through training, the model is evaluated on a separate test set. This final evaluation provides an unbiased assessment of the model's ability to generalize to new, unseen data. The training process is an iterative and dynamic one. Model performance is continually monitored, and improvements can be made by adjusting various components, retraining the model with more data, or updating the model architecture as new techniques and advancements emerge. After successful training and validation, the model is deployed into real world applications.

However, there can inherent problems in the model that developers may not be aware of, this can be manifested by indirect bias. Indirect bias in an AI model refers to bias that is not explicitly programmed or incorporated into the model but emerges as a result of the model's training data, features it learns, or the way it generalizes patterns. Indirect bias is often unintended and can occur due to various factors such as proxy bias, historical bias, skewed training data, and feedback loop bias. Bias occurs when the AI model produces inaccurate or unfair predictions or decisions due to influence of underlying biases present in the training data or the model's design. Three example types of bias when training AI models are: data bias, algorithmic bias, and user interaction bias. Addressing bias in AI models facilitates ensuring fairness and avoiding discrimination. Several strategies can be employed to mitigate bias, examples include-diverse and representative training data, bias assessment and mitigation, regular monitoring and evaluation (audits), ethical guidelines and regulations. It's important to note that achieving complete bias-free AI models can be challenging, but taking proactive steps to identify, understand, and mitigate biases is a significant stride towards building fair and trustworthy AI systems.

In the past, AI systems were only able to identify and mitigate bias when it existed in available training sets. This is potentially problematic if bias exists under certain configurations that are not tested. Embodiments disclosed and claimed herein offer an alternate approach: instead of using traditional testing data, synthetic data sets are created that have been explicitly engineered to show various types of bias against unprivileged groups. These test sets can then be used to directly test a model built on an original training set. As such, absence of biased data in the original testing set would no longer prevent identification and mitigation of hidden bias. Instead, this allows for a targeted approach to testing data against extreme scenarios to ensure robustness of the model. These synthetically biased test sets allow for a proactive approach to bias mitigation at any stage of model building. It should be noted the innovation is not creation of synthetic data but rather its implementation using various synthetic data sets with bias built in (instead of traditional testing data) to detect bias in a model.

Detecting bias in an AI model can be a complex task that requires careful evaluation and analysis and is an ongoing process. Bias can be subtle and may require continuous monitoring, feedback analysis, and model updates to mitigate and reduce its impact. Transparency, collaboration, and interdisciplinary approaches involving experts in ethics, social sciences, and diverse stakeholders can contribute to a more comprehensive evaluation of bias in AI models.

There are various methods to detect bias in an AI model and are disclosed infra.

Evaluation on diverse data: Bias can become apparent when the AI model is evaluated on diverse and representative datasets. If the model consistently produces different outcomes or predictions for different demographic groups or exhibits disparities in accuracy, precision, recall, or other performance metrics across subgroups, it suggests presence of bias. Fairness statistics in an AI model are quantitative measures used to assess and evaluate fairness of a model's predictions or decisions across different demographic groups. These statistics provide insights into whether the model exhibits bias or unfair treatment towards certain groups and helps to identify areas that require improvement. It's desirable to choose appropriate fairness metrics based on the context and goals of the model and interpret results in conjunction with qualitative analysis and real-world impact assessment to gain a comprehensive understanding of fairness and potential biases in AI models.

Analysis of disparate impact: Disparate impact analysis involves examining whether the model's predictions disproportionately favor or disadvantage certain groups. By comparing outcomes for different groups, such as protected classes, it is possible to identify if there are unjustified disparities caused by the model's predictions.

Probing for sensitive attributes: Bias can be exposed by probing the model's responses to inputs with sensitive attributes explicitly manipulated. By modifying attributes, e.g., corresponding to historically disadvantages classes or demographics while keeping other input features constant, the model's behavior can be analyzed to identify any differential treatment based on those attributes.

Case studies and user feedback: Real-world case studies and user feedback can shed light on bias in AI models. If users or affected individuals report or experience unfair or biased outcomes, it indicates potential bias in the model's predictions or decisions.

Audit and transparency measures: Conducting audits and establishing transparency in AI systems can help expose bias. This involves examining the model's training data, decision-making processes, and underlying algorithms to identify potential sources of bias and investigate their impact on the model's behavior.

There are times when data scientists don't have the necessary data to test a model for potential unfair treatment of protected attributes. A novelty of embodiments is a method to test a model's estimation of bias by using synthetic datasets with known bias in order to ensure any bias is diagnosed and mitigated.

A concept of innovation disclosed herein is, first create a synthetic dataset from a training set in which the sensitive protected attributes are oversampled and/or simulated. (it should be noted that attributes are considers sensitive protective attributes). The AI model is trained on an original training dataset, and that model is used to generate model predictions on biased synthetic test sets. With those results, fairness metrics can be computed to understand how the model handled the synthetic bias. If the model is found to be performing unfairly on an unprivileged group, various types of mitigation strategies can be used to fine-tune the AI model, thereby increasing the model's robustness by increasing its fairness. The model's robustness is also increased by ensuring that the model has seen bias data that it may see in production. Using this process to test fairness of the model can facilitate ensuring models comply with fairness regulations before heading into production.

One or more embodiments are now described with reference to the drawings, where like referenced numerals are used to refer to like elements throughout. As used herein, the term “entity” can refer to a machine, device, component, hardware, software, smart device and/or human. In the following description, for purposes of explanation, numerous specific details are set forth in order to provide a more thorough understanding of the one or more embodiments. It is evident, however, in various cases, that the one or more embodiments can be practiced without these specific details.

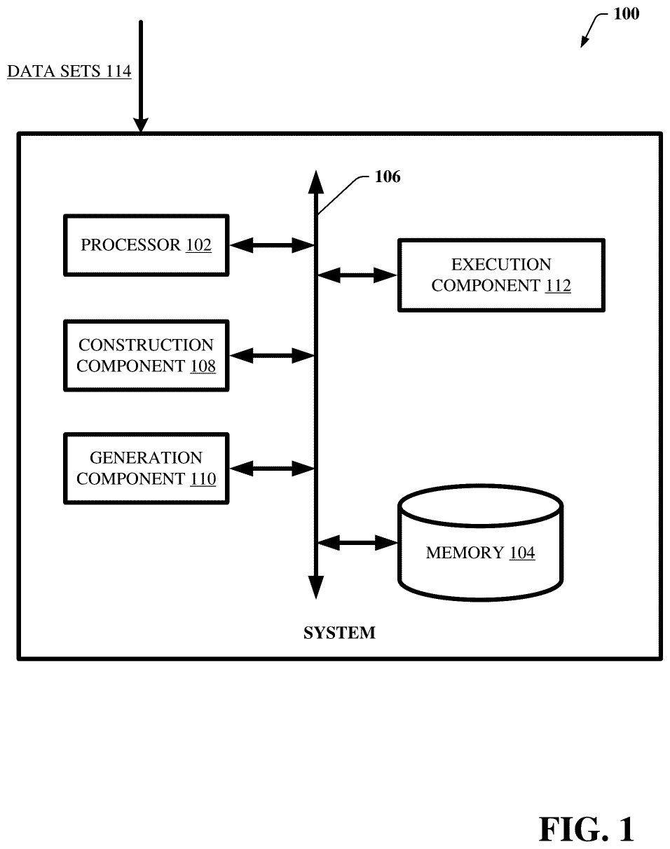

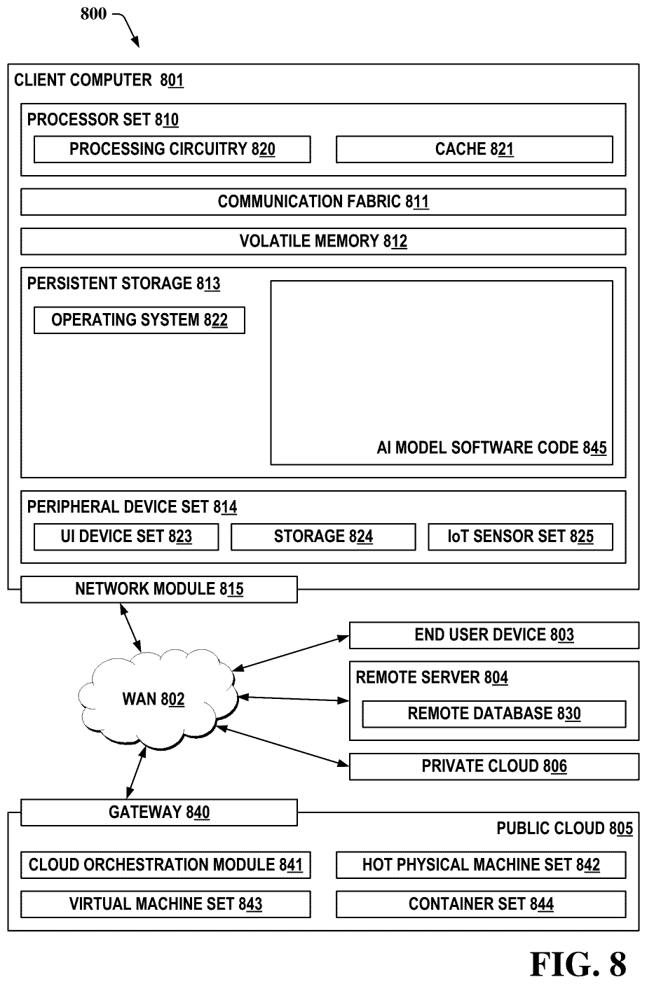

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting system described herein, such as 100 as illustrated at FIG. 1 can further comprise, be associated with and/or be coupled to one or more computer and/or computing-based elements described herein with reference to an operating environment, such as operating environment 800 illustrated at FIG. 8. In one or more described embodiments, computer and/or computing-based elements can be used in connection with implementing one or more of the systems, devices, components and/or computer-implemented operations shown and/or described in connection with FIG. 1, and/or with other figures described herein.

FIG. 1 depicts a basic block diagram 100 of components of an architecture which disclosed subject matter can interact/be implemented at least in part, in accordance with various aspects and implementations of the subject disclosure. This illustrates a block diagram of a non-limiting system 100 that can facilitate bias detection in an AI model utilizing synthetic data and a sequence of iterative testing in accordance with one or more embodiments described herein. The system 100 can comprise one or more components such as a memory 104, a processor 102, a bus 106, a construction component 108, a generation component 110, and an execution component 112. Generally, system 100 can facilitate bias detection in an AI model utilizing synthetic data and a sequence of iterative testing. The construction component 110 constructs an initial artificial intelligence (AI) model using a structured data set with continuous, binary or multi-class prediction labels. Structured datasets with binary or multi-class prediction labels are commonly used to train AI models for classification tasks. The generation component 110 generates various synthetic data sets employing established methods include random sampling, data augmentation, Generative Adversarial Networks (GANs), Variational Autoencoders (VAEs), copula models, rule based methods and Bayesian networks. After the synthetic data is created, the execution component 112 can run the model against the various synthetic biased testing data sets. The data sets the model will interface with are depicted as 114. This process can gage the performance of the model.

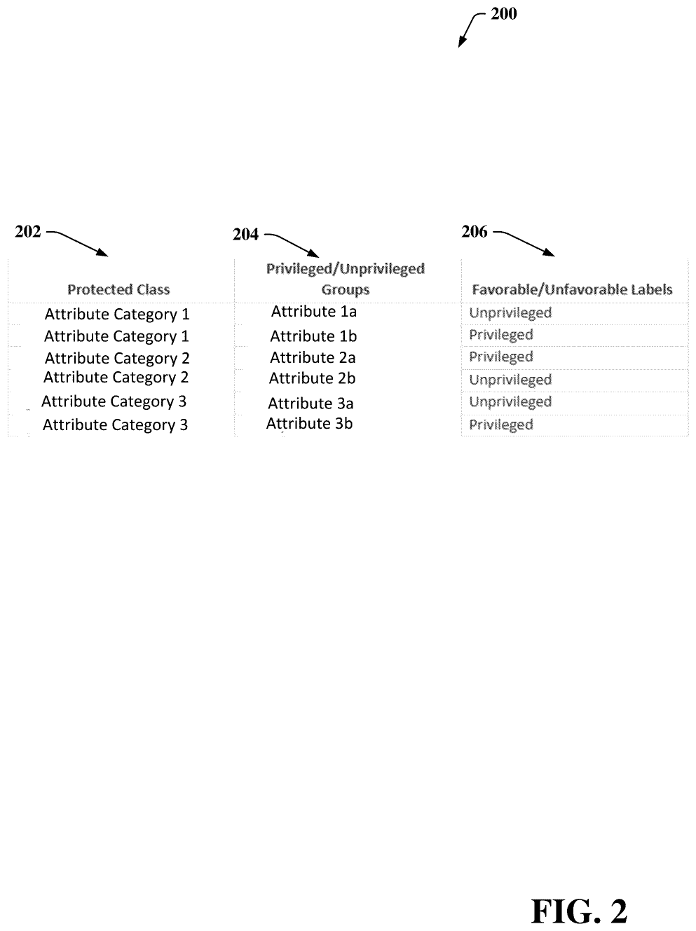

FIG. 2 depicts an example of a table 200 with columns representing various data that is used in the AI model for detecting bias. In this process, columns are identified as protected class 202, privileged/unprivileged groups 204, and favorable/unfavorable labels 206. In this example, the “Protected Class” column 202 has generic attribute categories identified as Attribute Category 1,2 and 3. These attributes categories could refer to gender, race, or others and can vary based on the application. The “Privileged/Unprivileged Groups” column 204 can be subsets of the attribute category (such as attribute la, 1b or other) and identify the population type within that attribute category (such as for example an attribute category could be “Gender” and the subset could be the actual gender type (M/F). This group or population type defines whether an individual belongs to a privileged or unprivileged group 204 within this context. The “Favorable/Unfavorable Labels” column 206 represents the classification labels assigned to the individuals, indicating whether they are deemed favorable or unfavorable based on the context. It's important to note that this is a simplified example only representation for demonstration purposes, and in real-world scenarios, the concept of protected classes, privileged/unprivileged groups, and favorable/unfavorable labels may be more nuanced and multifaceted. In the context of fairness and bias in AI, below are the definitions of protected class, privileged/unprivileged groups, and favorable/unfavorable labels:

Protected Class: A protected class refers to a group of individuals who are protected by anti-discrimination laws and regulations. These laws aim to prevent unfair treatment or discrimination based on certain characteristics that are considered fundamental and should not be the basis for differential treatment. Common protected classes include race, national origin, religion, gender identity, age, disability, and genetic information. In the context of AI, it is important to ensure that AI models do not perpetuate biases against protected classes and treat all individuals fairly.

Privileged/Unprivileged Groups: Privileged and unprivileged groups refer to groups of individuals who have varying levels of societal advantages or disadvantages. Privileged groups typically have access to more resources, opportunities, and advantages, while unprivileged groups face social, economic, or systemic disadvantages. Privileged/unprivileged groups can vary depending on the context, such as race, gender, socioeconomic status, or educational background. When evaluating AI models for fairness, it is crucial to ensure that they do not perpetuate or reinforce existing privilege or disadvantage for certain groups.

Favorable/Unfavorable Labels: Favorable and unfavorable labels represent the predicted outcomes or classifications assigned by an AI model. In a classification task, the labels are typically binary or multi-class predictions. For example, in a loan application scenario, a favorable label may indicate approval of the loan, while an unfavorable label may represent rejection. In the context of fairness, it is important to ensure that AI models do not disproportionately assign unfavorable labels to individuals from protected classes or unprivileged groups. A goal is to prevent unjust discrimination and biased outcomes based on membership in these groups.

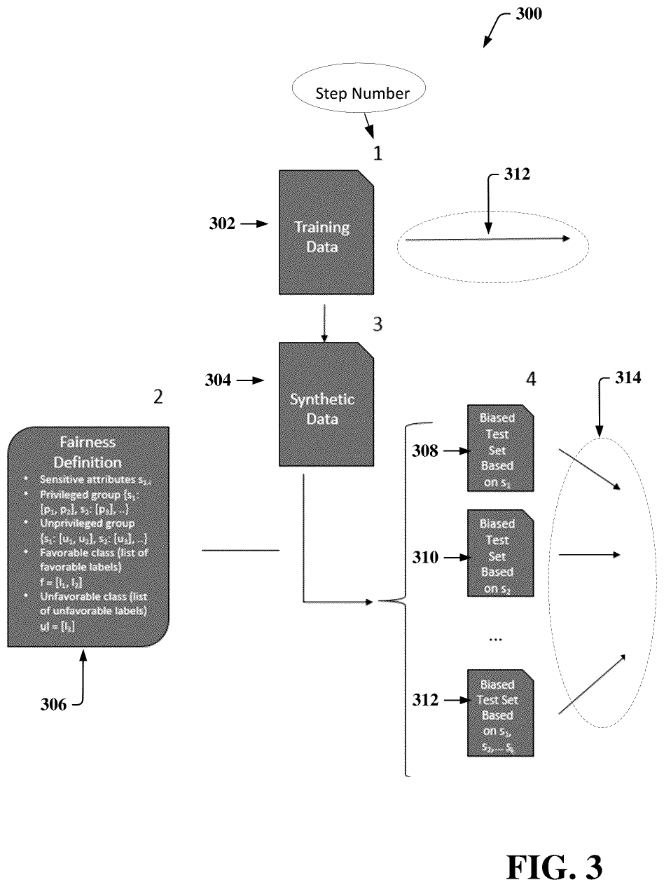

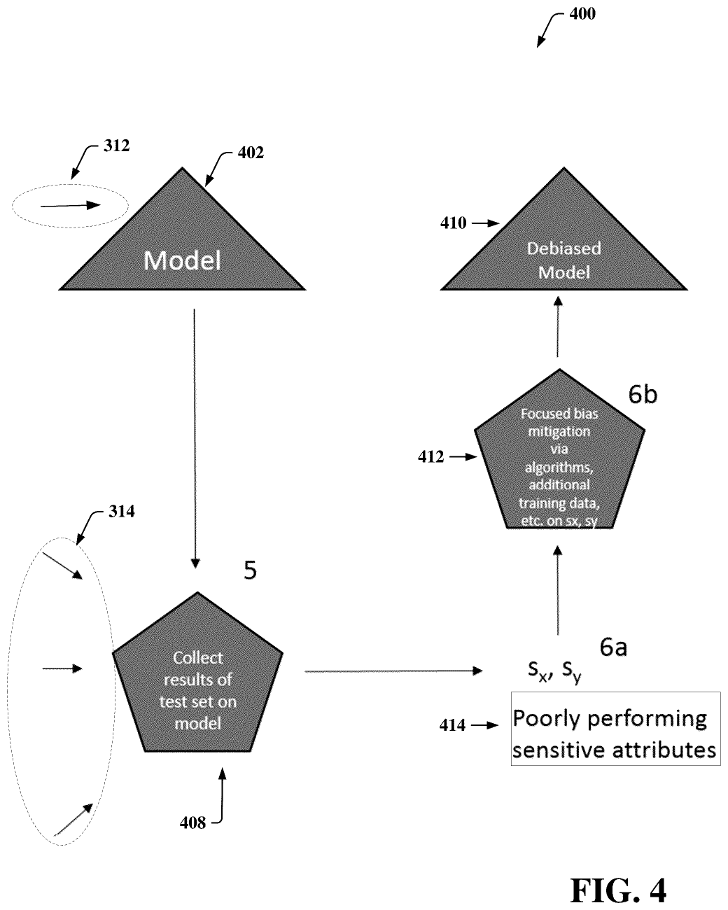

FIG. 3 illustrates the first part of a process 300 of generating synthetic biased data and the implementation of this data to detect bias in an AI model and associated components in accordance with one or more embodiments described herein. This figure is part 1 of the process and is combined with FIG. 4 to depict the entire process. Step 1 (302) refers to the initialization and training of the initial AI model. Structured data refers to data that is organized and formatted in a consistent and predefined manner, making it easily searchable and analyzable by computers. It is typically organized in a tabular or relational format, with well-defined rows and columns, where each column represents a specific attribute or variable, and each row represents an individual data entry or record. For example this data can include protected classes or privileged/unprivileged groups such as gender, race, and income as depicted in FIG. 2 along with any other amount of non-sensitive data needed to train the model.

In step 2 (306), the data set identified in step 1 is defined and labeled. For this example, there are different categories of data and is considered generic. The actual parameters are described in section 40. The data listed in 306 will determine the “AI Fairness number” as the model is run against the various biased data sets. Sensitive attributes are identified as S1, S2, S3 . . . and will vary based on the rules the model is subjected to. A sensitive attribute refers to an attribute or feature that is considered personal or sensitive, often related to protected characteristics. Sensitive attributes can include information about an individual's race, gender, religion, age, disability status, or any other attribute that may be subject to legal or ethical protection against discrimination.

Sensitive attributes are important to consider in AI and machine learning to ensure fairness and mitigate bias. When sensitive attributes are present in the data, AI models need to be designed and evaluated to prevent unfair or discriminatory outcomes based on these attributes. Treating individuals differently or making predictions that systematically disadvantage certain groups based on sensitive attributes can perpetuate biases and lead to unfair or discriminatory practices. It is crucial to handle sensitive attributes with care to avoid biased or discriminatory outcomes in AI systems. This involves strategies such as ensuring representative and diverse training data, evaluating models for fairness across different groups, and considering the potential impact of sensitive attributes on the model's predictions or decisions.

Definitions for AI datasets are typically provided through documentation or guidelines that accompany the dataset. These resources aim to provide clear and precise explanations of the dataset's structure, content, and labeling conventions. The documentation helps users understand the dataset, its intended use, and any specific considerations or limitations. AI datasets are labeled through a process known as data annotation or labeling. Data annotation involves assigning labels or annotations to the data points in a dataset, indicating the desired output or target variable for each data point. The labeled dataset serves as the ground truth for training and evaluating AI models. The defining and labeling that takes place in this step is specifically to identify within the data set definitions of protected classes, privileged/unprivileged groups, and favorable/unfavorable label(s). Labeling can take place using various methods and some common types of labeling techniques are:

Single-label classification: In this approach, each data point is assigned a single label from a predefined set of categories. For example, in an image classification task, each image is labeled with a single class label indicating the object present in the image (e.g., “cat.” “dog,” “car”). Single-label classification is commonly used for tasks where a data point belongs to only one category.

Multi-label classification: In multi-label classification, each data point can be associated with multiple labels simultaneously. This is often the case when a data point can belong to more than one category. For instance, in a document classification task, a document may be labeled with multiple topics or themes that are present in the document.

Regression: Regression labeling is used when the target variable is a continuous numerical value. Instead of discrete labels or categories, the data points are labeled with numeric values. For example, in a housing price prediction task, each data point (representing a house) is labeled with its corresponding price.

Sequence labeling: Sequence labeling is used for tasks where the goal is to label each element in a sequence or sequence of data points. It is commonly used in natural language processing tasks such as named entity recognition or part-of-speech tagging. In named entity recognition, for example, each word in a sentence is labeled to indicate whether it represents a person, organization, location, or other entities.

Structured labeling: Structured labeling involves assigning structured outputs or labels to data points. This approach is used when the labels have a more complex structure or when the relationships between the labels are important. For example, in semantic segmentation tasks in computer vision, each pixel in an image is labeled with a specific class, resulting in a structured output that represents the segmentation mask.

Weak supervision: In cases where manual labeling is costly or time-consuming, weak supervision techniques are used. Weak supervision involves using heuristics, rules, or automated methods to generate labels instead of relying solely on manual annotation. This approach can provide approximate labels at a larger scale, although the labels may be less accurate than manual labeling.

Active learning: Active learning is a labeling approach that combines manual and automated labeling. Initially, a small subset of data is manually labeled, and then the model is used to make predictions on the remaining unlabeled data. Human annotators then selectively label the data points where the model is uncertain or has low confidence. This iterative process focuses labeling efforts on the most informative data points, reducing the overall annotation workload.

The choice of labeling technique depends on the specific task, available resources, and the nature of the data. Each technique has its advantages and considerations and selecting the appropriate labeling approach is crucial for training accurate and effective AI models. If the requirement is examining a data set for gender and income, this could be classified as gender and income identifying favorable/unfavorable, privileged/unprivileged. For example, this data could be classified as follows. -{‘protected_attribute_columns’:[‘race’, ‘income’], ‘privileged_groups’:[[‘non-minority’], [‘male’], ‘unprivileged_groups’:[[‘minority’], [‘female’]], ‘favorable_label’:[1], ‘unfavorable_label’:[0]}. For an example there is one target column, “approval” and 2 protected attributes gender (privileged: male, unprivileged: female) and numeric variable income (privileged: over 120,000, unprivileged: under 120,000), the data set has other features columns used for predictions. This is an example only and not to be regarded as real world data.

In Step 3 (304), synthetic data is generated using any established method. Generating synthetic data involves creating artificial data samples that mimic the characteristics and patterns of real-world data. Synthetic data can be useful in scenarios where real data is limited, sensitive, or difficult to obtain. Some examples of established methods include random sampling, data augmentation, Generative Adversarial Networks (GANs), Variational Autoencoders (VAEs), copula models, rule-based methods and Bayesian networks.

Using a combinatorial approach (sampling from an intersection of protected classes), will drive Step 4 (308,310,312, . . . ) and biased test data sets will be generated. This involves a two-step approach where a test sample for each bias using the synthetic data is created. For example, when examining the sensitive attributes of gender and income in step 4, sub-step 1, generate a test data set for women and a test data set for income less than 120,000. In Step 4, sub-step 2, generate test data sets for the intersection of all unprivileged groups. Following the example, this would be a test data set of women with income less than 120,000.

For each combination of sensitive attributes, a test set is created that shows bias against an unprivileged group and an intersection of unprivileged groups (ex. for age and gender (where under 30 and female are unprivileged), create a test set that shows bias against women under 30). This can expand past just the combination of two sensitive attributes as long as sample size of intersectional group is large enough. The arrows 312 and 341 depict a connection to further steps in FIG. 4. Implementing these biased data sets to run with the model is a novel procedure to detect bias.

FIG. 4 illustrates the second part of a process 400 of generating synthetic biased data and the implementation of this data to detect bias in an AI model and associated components in accordance with one or more embodiments described herein. This figure is part 2 of the process and is combined with FIG. 3 to depict the entire process. The arrows 312 and 314 represent the continuation of the steps from FIG. 3. The model is depicted as 402 and is run against all the synthetic data sets that are generated. The next step is Step 5 (408) and the model executes against the synthetic data sets created. The model is run against all test data sets generated in Step 4. In the example given, we can have three test data sets representing the unprivileged groups, women and income less than 120,000, and the intersection of the groups, women with income less than 120,000.

This step provides a method for analyzing the robustness of the model in relation to the bias represented by the test data sets. Note when testing for indirect bias, the test sets are run through a model pipeline to associate sensitive attributes to data points.

Running an AI model pipeline to associate sensitive attributes to data points typically involves data preprocessing, feature engineering, model training, model evaluation, prediction on new data, and post-processing and analysis. It's important to note that handling sensitive attributes requires careful consideration to ensure privacy, fairness, and ethical considerations. Privacy protection techniques, such as anonymization or differential privacy, might be necessary to safeguard sensitive information. Additionally, steps should be taken to mitigate bias and ensure fairness in the prediction or association of sensitive attributes. The exact implementation of the AI model pipeline depends on the specific requirements of the task, the nature of the data, and the sensitive attributes involved. Consulting with domain experts and following best practices for data handling and ethical considerations is essential throughout the process. Test data set is also scored in Step 5 (408), for this example subset data sets identified as 308, 310 and 312 will be employed along with other synthetically created data sets.

Scoring an AI model typically involves evaluating its performance on a given task or dataset. The scoring process varies depending on the type of task and the specific evaluation metrics used. Common evaluation metrics include accuracy, precision, recall, F1 score, mean squared error (MSE), mean absolute error (MAE), and many others. In Step 5 (408), fairness statistics are used to evaluate the results of the test sets. Fairness statistics in an AI model are quantitative measures used to assess and evaluate the fairness of the model's predictions or decisions across different demographic groups. These statistics provide insights into whether the model exhibits bias or unfair treatment towards certain groups and help identify areas that require improvement. Examples of fairness statistics include Statistical parity/demographic parity, Equal opportunity, Predictive parity, False positive/negative rates, Treatment equality, Calibration metrics. It's important to choose appropriate fairness metrics based on the context and goals of the model and interpret the results in conjunction with qualitative analysis and real-world impact assessment to gain a comprehensive understanding of fairness and potential biases in AI models.

From the results of the test sets, we can see which protected attributes our model is most susceptible to. In the example the scoring determined (Step 6a) 414 that sensitive attributes S(x) and S(y) were not performing satisfactorily. Exposing the sensitive attributes was produced by running this innovation process, as without the synthetically created bias data, the inherent bias may not have been detected. Next Step 6b (412) is implemented, as adding bias mitigation steps to the model pipeline in implemented in order to reduce bias the model may see in the future without needing to train on any biased data itself. This involves a two-step approach to identify which test set(s) performed with the lower score and which sensitive attributes they were based off of, and then implementing targeted bias mitigation using the sensitive attributes identified.

It's important to note that bias mitigation is a complex and evolving field, and there is no one-size-fits-all solution. The specific techniques and approaches for bias mitigation depend on the task, the data, and the context in which the AI model is being deployed. It is recommended to consult with domain experts, adopt fairness guidelines, and consider legal and ethical considerations to ensure effective and responsible bias mitigation. There are several common bias mitigation techniques used to address biases in AI models. Here are some widely used approaches:

Data preprocessing: This technique involves modifying the training data to reduce biases before training the model. It can include techniques such as reweighting the data, oversampling or under sampling specific groups, or removing or modifying biased attributes.

Algorithmic fairness: Fairness-aware algorithms are designed to explicitly address bias during model training. These algorithms incorporate fairness constraints or penalties into the learning process to ensure fair treatment across different groups or demographic categories.

Model regularization: Regularization techniques can be applied to encourage fairness in model predictions. Fairness constraints or regularization terms are added to the model's objective function to minimize disparities in predictions between different groups.

Bias-aware training: This approach involves training the model with an explicit awareness of the biases present in the data. The model is encouraged to learn representations that minimize the impact of biased attributes and reduce disparities in predictions.

Adversarial debiasing: Adversarial debiasing involves training a model to simultaneously predict the target variable while confusing an adversary trying to infer the sensitive attribute. This technique helps reduce the reliance of the model on the sensitive attribute and leads to fairer predictions.

Predefined fairness rules: Fairness rules can be defined a priori to ensure certain fairness criteria are met during the model's training and prediction phases. These rules can be based on legal or ethical guidelines or domain-specific requirements.

Post-processing: After the model has made predictions, post-processing techniques can be applied to adjust the predictions to achieve fairness. This can involve statistical reweighing of predictions, calibration techniques, or using decision thresholds optimized for fairness metrics.

Transparent and interpretable models: Using models that are inherently interpretable, such as decision trees or linear models, can provide insights into the decision-making process and help identify and address biases more effectively.

External audits and evaluations: Independent external audits and evaluations can be conducted to assess the model's fairness and identify potential biases. These audits involve reviewing the model's performance and ensuring it meets predefined fairness criteria.

The result from performing bias mitigation related to the example sensitive attributes (S(x) and S(y)) 414 is a de-biased model 410 that is now improved as far as mitigating biased results based on the subset data it was tested against.

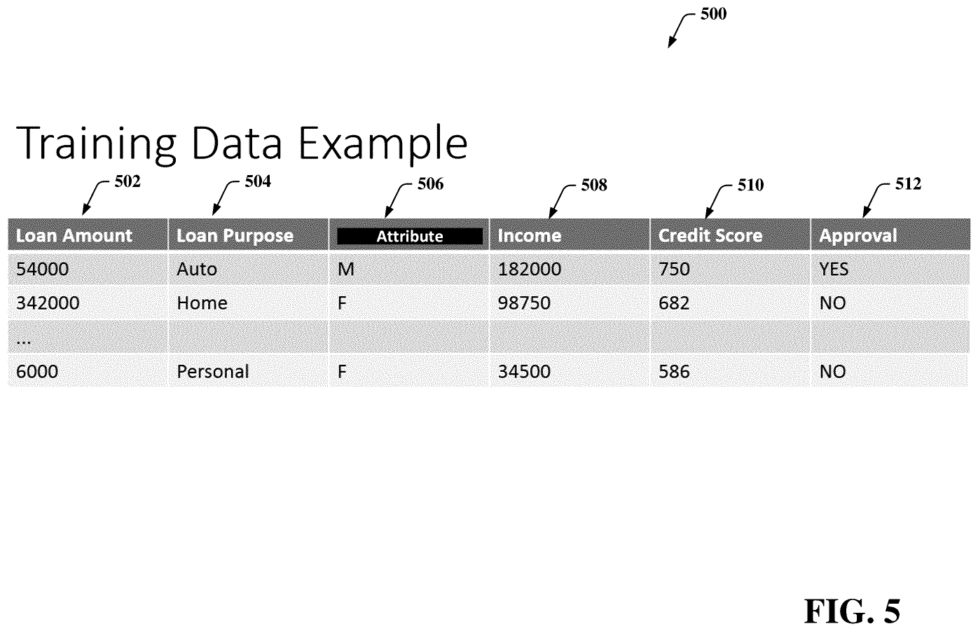

FIG. 5 illustrates an example of training data 500 that can be used for an AI model to predict “Approval or Rejection” for a specific loan type, in in accordance with one or more embodiments described herein. The training data reflects columns of data that could be used to accept or deny a loan to an applicant. The columns include loan amount 502, loan purpose 504, an attribute subset 506 (in this example the gender is identified), income 508, credit score 510 and the final result of approval or rejection in column 512. The attribute subset can be identified as shown in FIG. 2, attribute la, 1b (or whichever attribute category it falls into). An AI model can employ such data sets to drive the final approval or rejection output, and this is where possible bias can occur. As depicted in the chart, protected classes and privileged/unprivileged groups can be identified with the attribute subset column and the innovation can be applied to this type of a selection process to mitigate inherent bias.

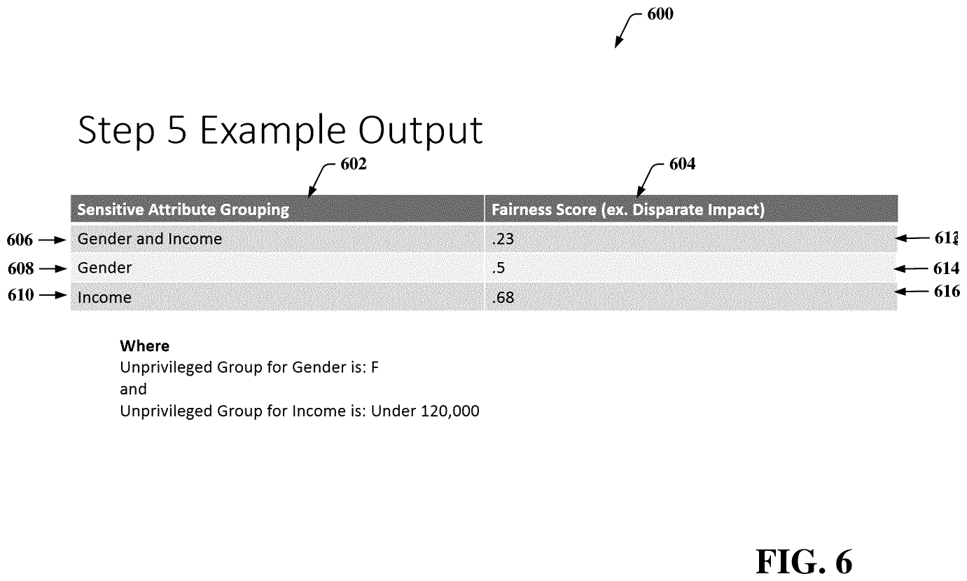

FIG. 6 illustrates an example of the output 600 of the process that can indicate if the model is bias and its specific sensitive attributes associated, in accordance with one or more embodiments described herein. For this example, column 602 identifies the sensitive attribute grouping. This could be individual or a combination of categories. This is depicted in 606 where a combination of gender and income are the sensitive attributes along with gender only 608 and income only 610. The fairness scores are identified in column 604 for each sensitive attribute. Fairness scores in AI models can provide quantitative measures that indicate the level of fairness or bias present in the model's predictions or outcomes. The specific values depend on the fairness metric being used. It's important to understand the specific fairness metric being used and its interpretation within the context of the AI system and the fairness concerns at hand. Additionally, fairness scores should be interpreted alongside other relevant factors and domain knowledge to get a comprehensive understanding of fairness in the AI model. A disparity index value (604) of 1 indicates no disparity, meaning the outcomes are equally distributed between the groups. Values greater than 1 indicate that one group has a higher proportion of positive outcomes than the other group, suggesting a higher level of disparity or advantage for that group. Values less than 1 indicate that one group has a lower proportion of positive outcomes than the other group, suggesting a higher level of disparity or disadvantage for that group. In the example depicted, the lowest score of 0.23 (612) corresponds to the sensitive attribute combination of gender and income. Based on the circumstances of the testing, this can be potentially interpreted as bias against this group.

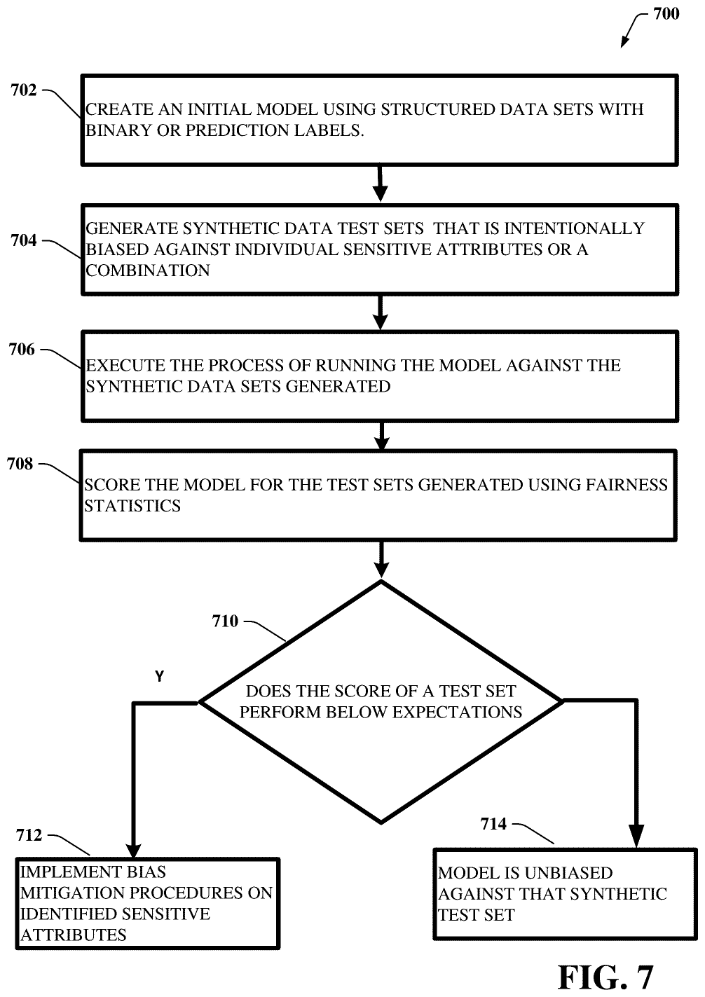

FIG. 7 illustrates a step-by-step flow chart diagram 700 in accordance with one or more embodiments described herein. Step 702 is the initial step it is to create an initial model using structured data sets with binary or prediction labels. Step 704 is to generate synthetic data test sets that are intentionally biased against individual sensitive attributes or a combination. Use a combinatorial approach (to sample from intersection of protected classes) to generate biased test set. For each sensitive attribute, create a test sample from the synthetic data that shows bias against unprivileged group. For each combination of sensitive attributes, create a test set that shows bias against intersection of unprivileged groups. This can expand past just the combination of two sensitive attributes as long as sample size of intersectional group is large enough. Step 706 is to execute the process of running the model against the synthetic data sets generated and Step 708 is to score the model for the test sets generated using fairness statistics. Based on these scores the decision block of 710 is employed to determine if there are sensitive attributes that reflect bias. If the score interpretation indicates bias, then mitigation procedures 712 are performed specific to those respective attributes and the model can be tested again. If the score is within a certain range, the use can interpret that there is no bias 714.

The following discussion are intended to provide a brief, general description of a suitable computing environment 800 in which one or more embodiments described herein at FIGS. 1-8 can be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as the AI software code 845. In addition to block 845, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 1. On the other hand, computer 801 is not required to be in a cloud except to any extent as may be affirmatively indicated.

Processor Set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 845 in persistent storage 813.

Communication Fabric 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent Storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 845 typically includes at least some of the computer code involved in performing the inventive methods.

Peripheral Device Set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network Module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way. EUD 803 can display, or otherwise present, the recommendation to an end user. In some embodiments, EUD 803 may be a client device, such as thin client, heavy client, mainframe computer, desktop computer and so on.

Remote Server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public Cloud 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on the user's computer, partly on the user's computer, as a stand-alone software package, partly on the user's computer or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks. The flowcharts and block diagrams in the figures illustrate the architecture, functionality, and operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that the one or more embodiments herein also can be implemented in combination with other program modules. Generally, program modules include routines, programs, components, data structures or the like that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” or the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Additionally, the disclosed memory components of systems or computer-implemented methods herein are intended to include, without being limited to including, these and any other suitable types of memory.

What is claimed is:

1. A computer implemented system, comprising:
a memory that stores computer executable components; and
a processor that executes the computer executable components stored in the memory, wherein the computer executable components comprise:
a construction component that constructs an initial artificial intelligence (AI) model using a structured data set with continuous, binary or multi-class prediction labels;
a generation component that generates synthetic datasets from the training set wherein sensitive protected attributes are simulated; and
an execution component that runs the initial AI model against synthetic datasets to gage robustness of the initial AI model by scoring the initial AI model for each test set and exposing the sensitive protected attributes to target for bias mitigation.

2. The computer-implemented system of claim 1, wherein sensitive protected attribute definitions are provided for the sensitive protected attributes including protected classes, privileged groups and unprivileged groups, and favorable labels and unfavorable labels.

3. The computer-implemented system of claim 1, wherein synthetic data is generated using techniques comprising at least one of Random Sampling, Data Augmentation, Variational Autoencoders (VAEs), Generative Adversarial Networks (GANs), Copula Models, Markov Chain Monte Carlo (MCMC) Methods and Rule-based Models.

4. The computer-implemented system of claim 1, wherein for each of the sensitive protected attributes, a test sample is created from the synthetic datasets that shows bias against an unprivileged group.

5. The computer-implemented system of claim 1, wherein for each combination of the sensitive protected attributes, a test set is created from synthetic data that shows bias against an intersection of unprivileged groups.

6. The computer-implemented system of claim 1, wherein for analyzing indirect bias, test sets are run through a model pipeline to associate the sensitive protected attributes to data points.

7. The computer-implemented system of claim 1, wherein a score is determined for the initial AI model using each individual test set.

8. The computer-implemented system of claim 7, wherein the determined score of test sets are analyzed using fairness statistics.

9. The computer-implemented system of claim 7, wherein the determined score of test sets can determine which of the sensitive protected attributes the initial AI model is most susceptible to.

10. The computer-implemented system of claim 8, wherein analysis of fairness statistics can identify which sensitive protected attributes are most sensitive to bias within the initial AI model.

11. A computer implemented method for using synthetic data sets to test for bias in an AI model, comprising:
constructing, by a system operatively coupled to a processor, the initial AI model using a structured data set with continuous, binary or multi-class prediction labels;
generating by the system, the synthetic datasets from a training set wherein the sensitive protected attributes are simulated and,
executing by the system, the initial AI model against the synthetic data sets to gage robustness of the initial AI model by scoring the initial AI model for each synthetic data set and exposing the sensitive protected attributes to target for bias mitigation.

12. The computer-implemented method of claim 11, further comprising:
generating, by the system, the synthetic datasets from the training set in which single or multiple sensitive protected attributes can be simulated.

13. The computer-implemented method of claim 12, further comprising:
creating, by the system, test samples from the synthetic datasets that shows bias against an unprivileged group.

14. The computer-implemented method of claim 11, further comprising:
analyzing, by the system, for indirect bias, the synthetic datasets that are run through a model pipeline to associate sensitive attributes to data points.

15. The computer-implemented method of claim 11, further comprising:
determining, by the system, a score for the model based on using each of the synthetic datasets and analysis of the model using fairness statistics.

16. The computer-implemented method of claim 15, further comprising:
determining, by the system, which sensitive protected attributes the initial AI model is most susceptible to.

17. The computer-implemented method of claim 15, further comprising:
identifying, by the system, which tests were performing below expectations and identifying the sensitive protected attributes contributing to the below expectations.

18. A computer program product for using synthetic datasets to test for bias in an AI model, the computer program product comprising a computer readable storage medium having program instructions embodied therewith, the program instructions executable by a processor to cause the processor to:
construct, by the processor, an initial artificial intelligence (AI) model using a structured data set with continuous, binary or multi-class prediction labels;
generate, by the processor, synthetic datasets from a training set in wherein sensitive protected attributes are simulated; and
execute, by the processor, the initial model against synthetic data sets to gage robustness of the initial model and scoring the initial AI model for each dataset and exposing the sensitive protected attributes to target for bias mitigation.

19. The computer program product of claim 18, wherein the program instructions are further executable by the processor to cause the processor to:
generate, by the processor, synthetic data using techniques comprising at least one of Random Sampling, Data Augmentation, Variational Autoencoders (VAEs), Generative Adversarial Networks (GANs), Copula Models, Markov Chain Monte Carlo (MCMC) Methods and Rule-based Models.

20. The computer program product of claim 18, wherein the program instructions are further executable by the processor to cause the processor to:
create, by the processor, test samples from synthetic datasets that shows bias against an unprivileged group.
